(19) United States
(12) Patent Application Publication
(10) Pub. No.: US 2026/0331522 A1
(43) Pub. Date: Oct. 22, 2026

(54) Ultra-Thin Current Collectors for Lithium-Ion Batteries

(71) Applicants: Alliance for Energy Innovation, LLC, Golden, CO (US); Colorado School of Mines, Golden, CO (US)

(72) Inventors: Ryan Ray BROW, Arvada, CO (US); Lydia Elaine MEYER, Arvada, CO (US); Jason Morgan PORTER, Arvada, CO (US); Maxwell Connor SCHULZE, Golden, CO (US)

(21) Appl. No.: 19/569,051

(22) Filed: Mar. 17, 2026

Related U.S. Application Data
(60) Provisional application No. 63/790,200, filed on Apr. 17, 2025.

(51) Int. Cl. H01M 4/66; H01M 4/04; H01M 4/74; H01M 10/0525; H01M 10/0587; H01M 50/109; H01M 50/403; H01M 50/414; H01M 50/491

(52) U.S. Cl. CPC H01M 4/666; H01M 4/0404; H01M 4/0409; H01M 4/661; H01M 4/74; H01M 10/0525; H01M 10/0587; H01M 50/109; H01M 50/403; H01M 50/414; H01M 50/491

(57) ABSTRACT

An ultra-thin current collector for lithium-ion batteries includes a polymeric separator having a first primary surface and a second primary surface, the collector addressing weight and energy density limitations of traditional designs. A first layer comprising active materials is disposed on the primary surface of the polymeric separator, the active materials being coated directly onto the separator to achieve a thickness in the range of less than 1.0 μm in some examples. The batteries can also include layers having a material selected from non-woven copper cloth and CuNi-coated felt in electrical contact with one or more of the active materials. A configuration incorporating the ultra-thin current collector improves energy density, reduces internal resistance, and enhances flexibility. A battery architecture supported by the configuration includes tab-less designs and faster charge-discharge rates.

### REFERENCE TO RELATED APPLICATIONS

This application claims the benefit of U.S. Provisional Patent Application No. 63/790,200, filed on Apr. 17, 2025, which is hereby incorporated by reference in its entirety.

### STATEMENT OF GOVERNMENT INTEREST

This invention was made with United States government support under Contract No. DE-AC36-08GO28308 awarded by the U.S. Department of Energy. The United States government has certain rights in this invention.

### TECHNICAL FIELD

The present teachings relate generally to method of improving energy density and performance in lithium-ion batteries and, more particularly, to ultra-thin current collectors for lithium-ion batteries.

### BACKGROUND

Lithium-ion batteries are frequently employed in portable electronics, electric vehicles, and large-scale energy storage systems. A lithium-ion battery typically consists of current collectors, anode and cathode active materials, one or more separators, and an electrolyte. Some batteries can include a porous separator material that prevents electrical contact between the two electrodes while permitting ionic transport. The current collectors are typically made from copper or aluminum foil and function as electron conductors to facilitate the movement of electrons from the anode and cathode active material to an external circuit. They also play an important role in thermal conduction. A typical cell includes two electrodes separated by a porous separator material that prevents electrical contact while permitting ionic transport. The electrodes are supported on conductive substrates that provide a pathway for electron flow to an external circuit and assist in heat dissipation during operation. These conductive substrates are typically formed from metallic materials, which are engineered to withstand the mechanical stresses encountered during production and assembly processes.

While these conductive or metallic substrates offer reliable electrical conductivity and structural integrity, they contribute significantly to the overall mass and volume of the cell. In many cell designs, these components can account for a substantial portion of the total weight and footprint. Furthermore, the need to maintain sufficient substrate thickness for mechanical handling and processing limits potential gains in energy density. Additionally, thicker substrates can increase internal resistance, generate excess heat, and reduce flexibility in certain battery configurations.

Therefore, there remains a need for improved substrate configurations including current collectors that can remain functional while also having reduced thickness and mass, thereby enabling higher energy density and greater mechanical adaptability in lithium-ion batteries.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

The present disclosure is directed to a lithium-ion battery. The lithium-ion battery comprises a first separator material comprising a polymeric material having a first side and a second side, a first electrochemically active material layer directly disposed on the first side, a second separator material in contact with an electrolyte, and a second electrochemically active material layer directly disposed on the second side. The battery further comprises an electrolyte in contact with the second electrochemically active material layer and a current collector comprising a fabric, a metal, or a combination thereof. The polymeric separator may comprise polyethylene, polypropylene, or a combination thereof, and the first electrochemically active material layer may comprise an anode such as graphite, silicon, lithium metal, or lithium oxide. The current collector may comprise copper-nickel-coated felt copper-coated felt, or non-woven copper cloth having a thickness of from about 0.1 μm to about 0.3 μm. The battery may store at least 100 mAh/cm³ per unit volume and exhibit a specific energy density greater than 100 Wh/kg. Accordingly, the battery may be configured as a coin cell or a pouch cell. In some embodiments, the cathode, anode, or the separator is porous, with the electrolyte disposed within one or more pores.

The present disclosure is also directed to a method of manufacturing a lithium-ion battery. The method comprises providing a continuous polymeric separator web having opposed surfaces, roll-to-roll coating a slurry containing an electrochemically active material directly onto at least one of the opposed surfaces to form an active material layer, and drying the coated web. A conductive current collector layer, free of active material and having a thickness of from about 0.1 μm to about 1.0 μm, is then deposited onto the active material layer by laminating copper-nickel-coated felt or non-woven copper cloth, or by thermal evaporation, sputtering, electrodeposition, or a combination thereof. The treated web is assembled into a lithium-ion cell together with a counter-electrode, an electrolyte, and a housing. In some embodiments, active material is coated and dried on both opposed surfaces to provide opposing anode and cathode electrodes on the separator web prior to assembly.

The present disclosure is further directed to a lithium-ion battery subassembly. The subassembly comprises a polymeric separator sheet having first and second surfaces, a first electrochemically active material layer directly disposed on the first surface, a second electrochemically active material layer directly disposed on the second surface, and a current collector in electrical contact with one of the electrochemically active material layers while being free of the other. The first electrochemically active material layer may comprise an anode, and the current collector may comprise an electrically conductive mesh, fabric, non-woven cloth, or a metal film having a thickness of from about 0.1 μm to about 1.0 μm.

The features, functions, and advantages that have been discussed can be achieved independently in various implementations or can be combined in yet other implementations further details of which can be seen with reference to the following description.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1 is an exploded schematic of an exemplary battery having a traditional current collector as compared to a battery having an ultra-thin current collector, in accordance with the present disclosure.

FIGS. 2A and 2B illustrates (FIG. 2A) a system for preparing an electrode on a separator of a lithium-ion battery and (FIG. 2B) a resulting lithium-ion battery having an electrode on a separator, according to some aspects of the present disclosure.

FIG. 3 illustrates methods of preparing an electrode on a separator of a lithium-ion battery enabling the use of fabric-type current collectors, according to some aspects of the present disclosure.

FIGS. 4A-4C illustrate 3C (FIG. 4A), 5C (FIG. 4B), and 7C (FIG. 4C) charge and C/2 discharge with a 20-minute voltage hold after each charge and discharge for electrodes on a separator of a lithium-ion battery, according to some aspects of the present disclosure.

FIGS. 5A and 5B illustrates a Nyquist plot (FIG. 5A) and a Nyquist plot: electron movement (FIG. 5B) for electrodes on a separator of a lithium-ion battery, according to some aspects of the present disclosure.

FIGS. 6A and 6B are plots of cycling data comparing the cathode specific capacity of cells manufactured with traditional or ultra-thin current collectors (FIG. 6A). Cycling data from the literature showing the cathode specific capacity for cells with the same architecture of a traditional cell is shown in FIG. 6B, in accordance with the present disclosure.

FIG. 7 is a plot exhibiting cycling data comparing the cell stack specific capacity of cells manufactured with traditional or ultra-thin current collectors, in accordance with the present disclosure.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same, similar, or like parts.

The embodiments described herein should not necessarily be construed as limited to addressing any of the particular problems or deficiencies discussed herein. References in the specification to “one embodiment”, “an embodiment”, “an example embodiment”, “some embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein the term “substantially” is used to indicate that exact values are not necessarily attainable. By way of example, one of ordinary skill in the art will understand that in some chemical reactions 100% conversion of a reactant is possible, yet unlikely. Most of a reactant may be converted to a product and conversion of the reactant may asymptotically approach 100% conversion. So, although from a practical perspective 100% of the reactant is converted, from a technical perspective, a small and sometimes difficult to define amount remains. For this example of a chemical reactant, that amount may be relatively easily defined by the detection limits of the instrument used to test for it. However, in many cases, this amount may not be easily defined, hence the use of the term “substantially”. In some embodiments of the present invention, the term “substantially” is defined as approaching a specific numeric value or target to within 20%, 15%, 10%, 5%, or within 1% of the value or target. In further embodiments of the present invention, the term “substantially” is defined as approaching a specific numeric value or target to within 1%, 0.9%, 0.8%, 0.7%, 0.6%, 0.5%, 0.4%, 0.3%, 0.2%, or 0.1% of the value or target.

As used herein, the term “about” is used to indicate that exact values are not necessarily attainable. Therefore, the term “about” is used to indicate this uncertainty limit. In some embodiments of the present invention, the term “about” is used to indicate an uncertainty limit of less than or equal to ±20%, ±15%, ±10%, ±5%, or ±1% of a specific numeric value or target. In some embodiments of the present invention, the term “about” is used to indicate an uncertainty limit of less than or equal to ±1%, ±0.9%, ±0.8%, ±0.7%, ±0.6%, ±0.5%, ±0.4%, ±0.3%, ±0.2%, or ±0.1% of a specific numeric value or target.

Lithium-ion batteries are widely used in applications ranging from portable electronics to electric vehicles and large-scale energy storage systems. A significant component of these batteries is the current collector, typically made of copper or aluminum foil, which facilitates electron flow between the electrodes and the external circuit while also aiding in thermal conduction. However, conventional current collectors present notable limitations. Their thickness, required for mechanical stability during roll-to-roll (R2R) coating and handling, contributes considerably to the overall weight and volume of the battery. This non-active material can account for up to 25% of the areal mass of a cell stack, 11% of the volume of the cell stack, and 15% of the raw material cost, without directly contributing to energy storage. Additionally, the thickness of these metallic substrates reduces the flexibility of the battery, particularly in advanced configurations. These limitations hinder the energy density, cost efficiency, and adaptability of lithium-ion batteries, creating a need for solutions to reduce the thickness and mass of current collectors without compromising their functionality.

The present disclosure addresses these challenges by introducing ultra-thin current collectors and a novel method of battery fabrication that shifts the role of the mechanical substrate from the current collector to the separator. In this approach, active materials are coated directly onto the separator, which has comparable tensile strength to aluminum but significantly lower density. This eliminates the need for thick metallic foils as mechanical supports, allowing the current collectors to be reduced to ultra-thin films with thicknesses as low as 0.1 μm to about 1.0 μm, achieved through advanced deposition techniques such as thermal evaporation, sputtering, or electrodeposition. By decoupling the mechanical and electrical roles of the current collector, the described method enables the use of non-traditional materials, such as mesh, fabric, or non-woven copper cloth, further reducing weight and enhancing flexibility.

This design features of the present disclosure not only reduces the mass and volume of the current collectors but also improves the energy density of the battery by 10-20% and lowers raw material costs by 5-10%. Additionally, the reduced thickness and/or the increased active material-current collector contact area minimizes internal resistance, enhancing thermal management and enabling faster charge and discharge rates. This design and associated features also support advanced battery architectures, such as tab-less designs, which distribute current more uniformly and reduce peak temperatures. Initial testing has demonstrated that batteries utilizing these ultra-thin current collectors maintain comparable or superior performance to traditional designs, with increased capacity retention and improved cycle life. This approach represents advancement in lithium-ion battery technology, addressing the limitations of conventional designs while enabling higher energy density, improved safety, and greater adaptability for next-generation applications.

Among other things, the present disclosure relates to a method to reduce current collector thickness in lithium-ion batteries by up to approximately 98%. The method of the present disclosure does not describe the conventional roll-to-roll coating active materials onto current collectors, but instead describes coating active materials onto the separator. A typical separator has a tensile strength comparable to aluminum, but approximately 15-25% of the density of aluminum. For the method of the present disclosure, first slurries containing active materials may be roll-to-roll coated onto both sides of the separator. Then, copper and aluminum current collectors may be deposited as a thin film via thermal evaporation, sputtering, or electrodeposition. As the mechanical strength of the current collector is not a concern, the current collector may be as thin as its electrical resistivity may allow (in some examples, about 0.1-0.3 μm).

For the purposes of the present disclosure, the following non-limiting terms are defined.

An active material is a material within a battery, or in particular, a lithium-ion battery, that stores energy and participates in electrochemical reactions during charge and discharge cycles. Examples of active materials according to the present disclosure can include graphite, silicon, lithium iron phosphate, and nickel-rich NMC cathodes.

A current collector is defined as a conductive substrate, in examples, made of copper or aluminum, that facilitates electron flow between the electrodes of a battery and an external circuit. Current collectors can also aid in thermal conduction. A separator can be considered as a porous synthetic resin material, such as polyethylene (PE) or polypropylene (PP), that prevents electrical contact between the anode and cathode while allowing ionic transport. In examples of the present disclosure, a current collector refers to a non-traditional current collector made from materials such as mesh, felt, or non-woven copper cloth, offering reduced thickness and improved flexibility in a battery design. A tab-less cell design refers to an element of battery architecture that eliminates traditional tabs, distributing current uniformly and reducing peak temperatures within the electrodes. In examples of the present disclosure, a synthetic resin-based electrolyte can include an electrolyte formulation that enhances conductivity and compatibility with lithium-ion battery components. NMC811 Cathodes can refer to cathode or electrode materials which can include a cathode material composed of nickel, manganese, and cobalt in an 8:1:1 ratio, offering high energy density and stability. In examples of the present disclosure, a graphite anode can be or include an anode material made primarily of graphite. In other examples, the anode can be made from silicon, lithium metal, or lithium oxide. Specific types of separators can include a Celgard 2500 separator which is a specific type of polyethylene-based separator with a thickness of approximately 25 μm. Batteries of the present disclosure can also include conductive carbon added to electrodes, binders such as polyvinylidene fluoride (PVDF) binders, which can be one or more polymer binders used in electrode formulations to hold active materials together. Battery architecture can also include pouch cells, coin cells, or other types of cells. A pouch cell refers to a type of lithium-ion battery with a flexible, lightweight casing.

In examples of the present disclosure, an interfacial layer can be disposed between either the first electrochemically active material layer and the current collector or the second electrochemically active material layer and its respective current collector. This interfacial layer can be applied by one of the methods described herein, or by a method known to a skilled artisan. The interfacial layer can be carbon-based or non-carbonaceous and comprises a conformal, electronically conductive adhesion layer selected from a conductive polymer network, a metal oxide, a metal nitride, or a combination thereof, the interfacial layer having a thickness from about 50 nm to about 800 nm, or from about 10 nm to about 1 micron, or from about 50 nm to about 400 nm.

In examples of the present disclosure several fabrication or assembly steps can be utilized in battery manufacturing. For example, electrolyte wetting time can refer to the time required for the electrolyte to fully saturate the separator and electrodes, affecting battery performance. Roll-to-roll coating is a manufacturing process where active materials are applied to a substrate, such as a separator or current collector, using continuous rolls for efficient production. Calendering is a manufacturing process where electrodes or materials used in the construction or fabrication of electrodes are compressed to improve surface smoothness and reduce porosity. Deposition techniques for battery fabrication can further include thermal evaporation, a deposition technique used to create thin films of materials, such as copper or aluminum, by heating the material until it vaporizes and condenses onto a substrate, sputtering, a physical vapor deposition method where particles are ejected from a target material and deposited as a thin film onto a substrate, or electrodeposition, a process of depositing a material onto a substrate using an electric current, commonly used for creating thin films of metals like copper or aluminum.

The following definitions or terms are relevant to the physical or electrical characterization and measurement of batteries as described in the present disclosure. Energy density refers to the amount of energy a battery is capable of storing relative to its mass or volume, and is commonly expressed in units such as watt-hours per kilogram (Wh/kg) or milliamp-hours per cubic centimeter (mAh/cm³). This metric is often used to compare how much usable energy different battery designs can deliver in a given size or weight. Specific energy describes the energy storage capacity of a battery per unit weight, typically measured in Wh/kg, and serves as an indicator of how efficiently a battery stores energy relative to its mass.

A Nyquist plot is a graphical representation of impedance data that illustrates the relationship between real and imaginary impedance components, and is commonly used to analyze electrical and ionic resistance, interfacial behavior, and charge-transfer processes within a battery. The C-rate is a measure of how quickly a battery is charged or discharged relative to its rated capacity, where a rate of 1C corresponds to fully charging or discharging the battery in one hour. Capacity retention describes a battery's ability to maintain its original storage capacity over repeated charge-discharge cycles, and is a key indicator of long-term performance and durability. Tensile strength is a measure of a material's resistance to breaking under applied tension and is often used to characterize the mechanical robustness of battery components such as separators and current collectors. Electrochemical impedance spectroscopy (EIS) is a diagnostic technique used to measure electrical and ionic resistance in a battery across a range of frequencies, providing insight into charge transfer, diffusion processes, and performance degradation mechanisms. Voltage hold refers to a step in a battery cycling protocol in which the battery voltage is maintained at a constant level for a specified period during charging or discharging, often to improve capacity utilization or evaluate stability. Internal resistance is the inherent resistance within a battery that influences efficiency, voltage drop, and heat generation during operation. Cycle life denotes the number of complete charge-discharge cycles a battery can undergo before its capacity declines beyond an acceptable threshold. Areal loading refers to the quantity of active material present per unit area of an electrode, typically expressed in mAh/cm², and is an important parameter in determining electrode performance and energy density. Lithium concentration polarization is a phenomenon in which lithium ions become unevenly distributed during battery operation, leading to localized concentration gradients that can degrade performance and increase resistance. Lithium dendrite growth involves the formation of needle-like lithium structures during cycling, which can penetrate separators, cause internal short circuits, and compromise battery safety. Electrode curl describes a mechanical deformation in which an electrode bends or warps, often as a result of internal stresses introduced during manufacturing or electrochemical cycling. Fault current is an abnormally high current that flows during a short-circuit or failure condition, posing potential safety risks such as overheating or thermal runaway. Specific capacity represents the charge storage capacity per unit mass of active material, typically measured in mAh/g, and reflects the intrinsic electrochemical capability of the electrode material. Volumetric capacity refers to the amount of charge a battery can store per unit volume, providing a measure of energy storage efficiency in applications where compact form factors are critical.

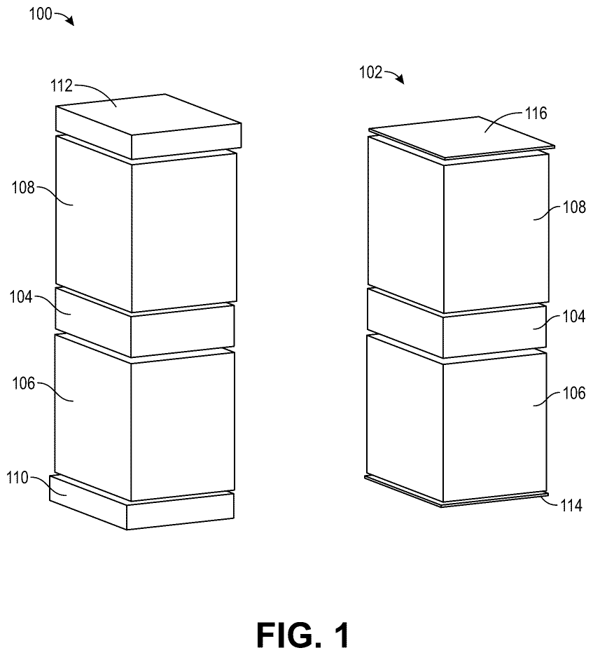

FIG. 1 is an exploded schematic of an exemplary battery having a traditional current collector as compared to a battery having an ultra-thin current collector, in accordance with the present disclosure. FIG. 1 shows both a battery with conventional current collectors 100 and a battery with ultra-thin current collectors 102. Each of the batteries include a separator 104, an anode material 106, and a cathode material 108. The conventional current collectors 100 includes a first traditional current collector 110 in contact with the material 106 and a second traditional current collector 112 in contact with the cathode material 108. By contrast, the ultra-thin current collectors 102 includes a ultra-thin current collector 114 in contact with the material 106 and a second ultra-thin current collector 116 in contact with the cathode material 108. It should be noted that for purposes of clarity not every detail of the conventional current collectors 100 and ultra-thin current collectors 102 are depicted but would be known to one skilled in the art. It should further be noted that the battery is independent of form factor, and could be configured as a coin cell, a cell having a pouch, cylindrical, or prismatic form factor, or others. Exemplary anode materials for batteries of the present disclosure can include graphite, or other carbon-based materials, silicon, lithium metal, lithium alloys, or combinations thereof. Exemplary cathode materials for batteries of the present disclosure can include Lithium nickel manganese cobalt oxides (NMC oxides), lithium, lithium cobalt oxide, lithium manganese oxide, lithium nickel cobalt aluminium oxide, lithium iron phosphates, or combinations thereof.

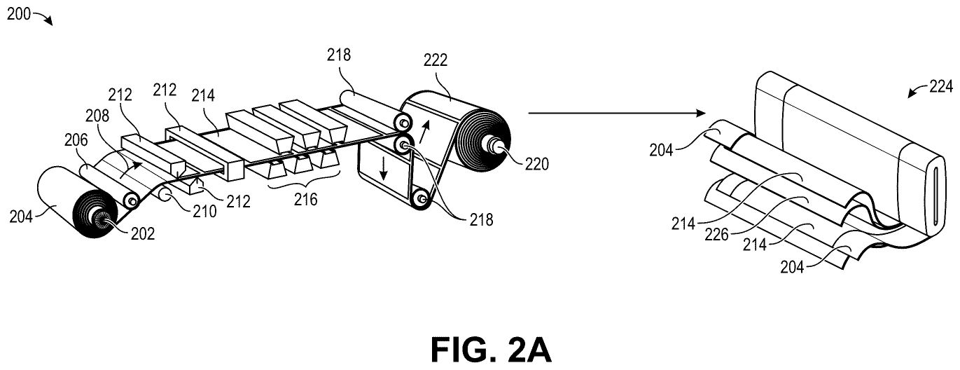

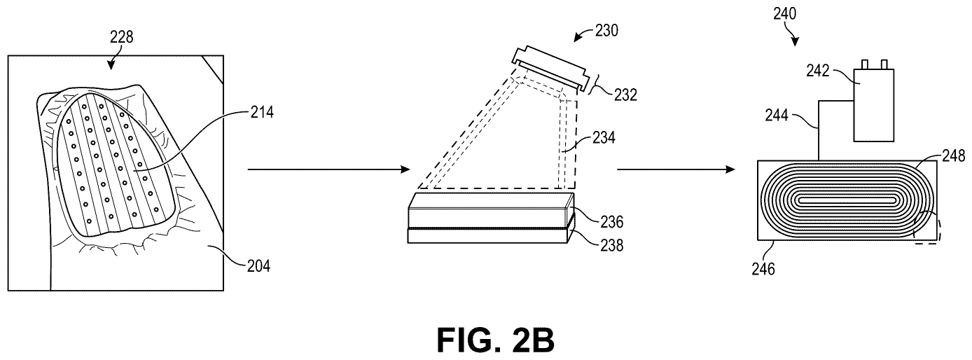

FIGS. 2A and 2B illustrates (FIG. 2A) a system for preparing an electrode on a separator of a lithium-ion battery and (FIG. 2B) a resulting lithium-ion battery having an electrode on a separator, according to some aspects of the present disclosure. The system 200, as shown in FIG. 2A, includes many components typical of a roll-to-roll preparation for a lithium-ion battery. The system 200 and process for preparing an electrode on a separator material includes a supply roll 202 holding a separator material 204 as a substrate, a tension roll 210 to maintain tension on the substrate or separator material 204 as it is transferred from roll to roll in process direction 208, coating applicators 212 for applying the active materials 214, a drying system 216 for setting the active materials 214 on the separator material 204, and calendar rolls 218 for directing the separator material 204. However, for the present disclosure, unlike typical lithium-ion battery construction, the coating applicators apply the active materials onto the separator 204, not the current collectors. The system 200 of the present disclosure provides a coated separator material with dried active materials 222 to be collected on an uptake roll 220. After coating, the one or more stored electrode materials 224 can be separated by a barrier layer 226.

FIG. 2B includes a photograph 228 of an electrode produced by the process and methods as described herein. Subsequently, a process 230 for depositing a metal 236 onto a substrate 238 can be conducted on one or more electrodes to provide a thinly deposited metal coating on the opposite side of the separator that includes the active material, using a metal cathode 232, producing metal vapor 234, resulting in a deposited metal 236 on a substrate 238. Next, a general assembly schematic 240 for a lithium-ion battery cell 242 is shown, the lithium-ion battery cell 242 having a positive and negative terminal. In such an example, a subassembly sheet 248 including a positive electrode, separator, and negative electrode subassembly 246 can be wound and coiled. The separator acts as an insulator, preventing direct contact and short-circuiting between the positive and negative electrodes. An electrical coupling 244 is shown, which connects the subassembly sheet 248 to the battery cell 242. While a specific depiction is shown herein, the configuration of the lithium-ion battery cell 242 can be a coin cell, a pouch configuration, a combination thereof, or an array of multiple cells thereof. In examples, the now coated separator and the ultimate separator in the LIB can be used in the battery as well. In such examples, it could be redundant to add another separator layer to the LIB later, but this is dependent upon the overall battery configuration and structure.

In some examples, during manufacture of lithium-ion battery electrodes, active materials are roll-to-roll coated onto current collectors. Current collectors are typically copper or aluminum foil (also referred to as a substrate). To maintain the mechanical properties necessary for roll-to-roll coating, typical thicknesses required for these foils are approximately 6 um for copper and approximately 10 um for aluminum. These foil thicknesses constitute a large (and “non-active”) percentage of the weight of the lithium-ion battery. It is estimated that the specific energy density of a lithium-ion battery can be increased by 5-20% if these current collectors could be made thinner (~0.2 um). The methods described herein may reduce the thickness of the current collectors by 1) not including active materials on the current collectors and/or 2) allowing for the use of non-traditional materials for current collectors.

In examples, by coating both electrodes on opposing sides of the separator, the current collector no longer serves as the mechanical substrate and can be made ultra-thin while still providing an electrical pathway. Vacuum metallization or thin-film evaporation can be used for current collectors. In particular, the addition of about 0.3 μm to about 0.8 μm of Al and/or Cu on the cathode and anode sides of the cell respectively, using techniques like thermal evaporation, electrodeposition, or physical lamination. These methods lower fault current for improved safety without decreasing volumetric capacity, improve compatibility with anode-cathode-anode sandwich architectures enabling faster charge via shorter transport, and reduce electrolyte wetting time when using patterned current collectors.

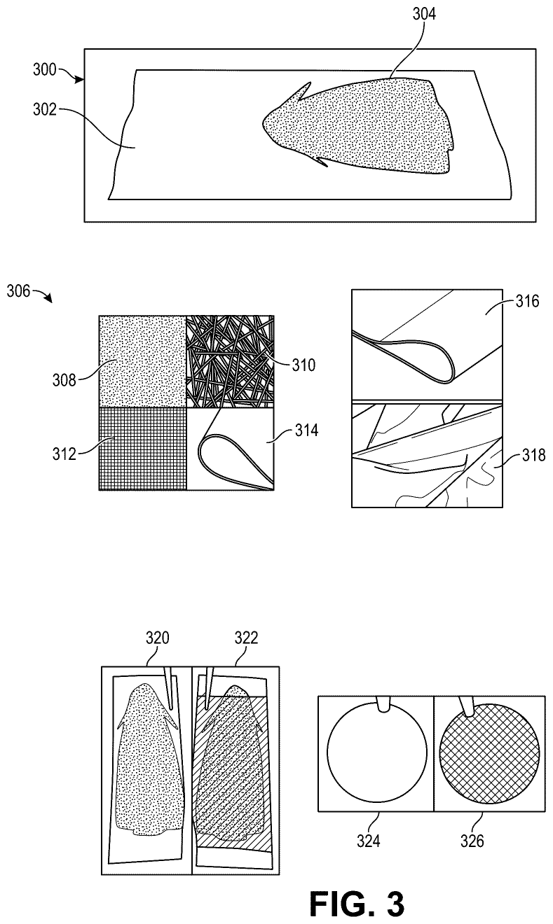

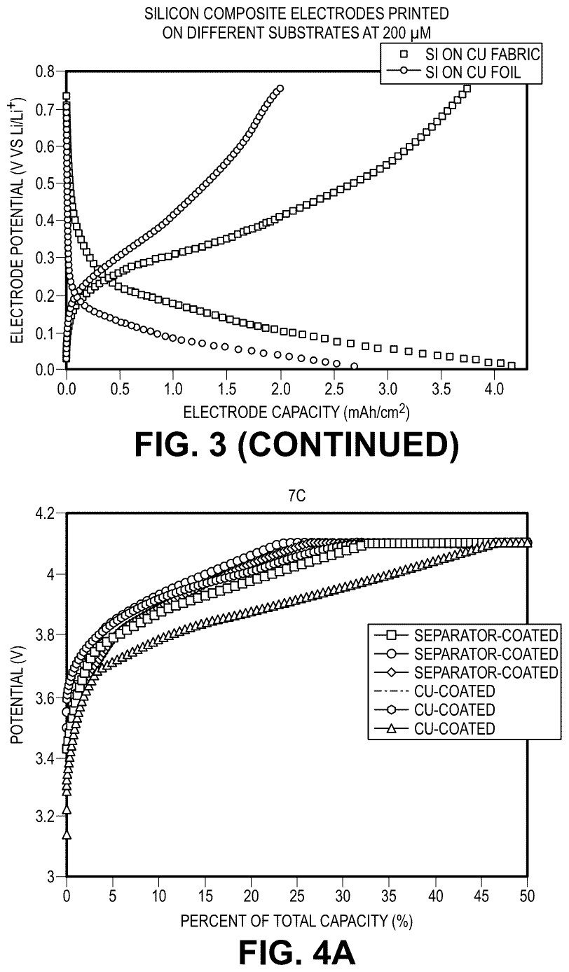

FIG. 3 illustrates methods of preparing an electrode on a separator of a lithium-ion battery enabling the use of fabric-type current collectors, according to some aspects of the present disclosure. FIG. 3 illustrates how preparing an electrode on a separator of a lithium-ion battery enables the use of fabric-type current collectors, according to some aspects of the present disclosure. Because in the methods described herein the active materials are applied to the separator, not the current collector, the current collector may be made of materials previously unusable as a current collector. For example, mesh, fabric, or even thinner foils may be used as current collectors. For example, copper nickel (CuNi) coated felt or non-woven copper (Cu) cloth may be used as current collectors. In some examples, the method of the present disclosure includes applying active materials (such as lithium oxide) onto the separator, not the current collector (i.e., on the separator, not the foil). The separator is typically a synthetic resin material, such as polyethylene (PE) and/or polypropylene (PP). As shown in FIG. 3, a silicon-based electrode 300 can be produced by depositing a silicon-based active material 304 onto a separator material 302. Also shown is a photograph of an exemplary copper-nickel coated felt 306 used as a current collector, shown at 4× magnification 308, 400× magnification 310, 1× magnification 312, and under no magnification 314. Additionally, an exemplary non-woven copper cloth 316 is shown, along with a microscopic view of the non-woven copper cloth 318. One or more of the non-woven copper cloth 316 or the copper-nickel coated felt 306 can be combined with the silicon-based electrode 300 material as shown, in a top view of electrode 320 with non-woven copper cloth on the top and a bottom view of electrode 322 with copper-nickel coated felt on the bottom. This material can then be processed for testing, evaluation, or fabrication into a battery by producing a 15 mm electrode punch, top view 324, also shown is a 15 mm electrode punch, bottom view 326. A plot of such silicon composite electrodes printed onto different substrates is also shown in FIG. 3.

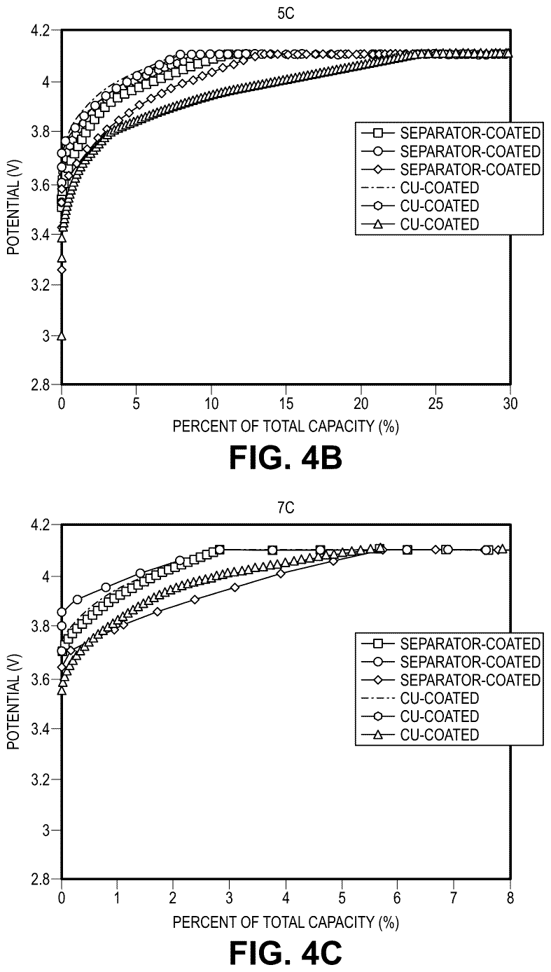

FIGS. 4A-4C illustrate 3C (FIG. 4A), 5C (FIG. 4B), and 7C (FIG. 4C) charge and C/2 discharge with a 20-minute voltage hold after each charge and discharge for electrodes on a separator of a lithium-ion battery, according to some aspects of the present disclosure. Cells prepared according to the present disclosure, in particular, lithium-ion batteries prepared with active materials on the separator, not on the current collector, performed substantially similarly and/or significantly better than traditional cells (i.e., lithium-ion batteries prepared with anode coated on a copper foil), as shown in Table 1. FIGS. 4A-4C exhibit how the cells formed as described by the present disclosure, specifically separator-coated cells, performed at least as well as traditional cells, including copper coated cells.

For the results shown in Table 1, cells LM014, LM015, and LM016 were prepared as standard lithium-ion coin cells. This included a cathode cap, a cathode of NMC811 coated onto an aluminum strip having a depth of approximately 14 mm. This had a loading of approximately 2.59 mAh/cm². A Gen2 electrolyte (approximately 30 μL). The traditional cells included a Celgard 2500 separator (having a thickness of approximately 25 μm), a gasket, and additional Gen2 electrolyte (approximately 30 μL). For the tested traditional cells shown in Table 1, the graphite anode was coated on copper (Cu) (approximately 92% graphite, approximately 2% conductive carbon, approximately 6% PVDF binder in NMP (approximately 2.5 wt %)) with a depth of approximately 16 mm. The traditional cells included one (1) stainless steel spacer, a wave spring, and an anode cap.

For the results shown in Table 1, cells of LM004, LM005, and LM006 were prepared using the methods described in this present disclosure to apply the active materials on the separator. Specifically, those cells formed as described in this present disclosure included a cathode cap, a cathode of NMC811 coated onto an aluminum strip having a depth of approximately 14 mm. This had a loading of approximately 3.07 mAh/cm². The cells formed as described in this present disclosure included a Celgard 2500 separator (having a thickness of approximately 25 μm), a gasket, and additional Gen2 electrolyte (approximately 30 μL). The cells formed as described in this present disclosure include graphite anode coated on the Celgard 2500 separator (in these cells the anode was approximately 94% graphite) which had a depth of approximately 16 mm. The cells formed as described herein included one (1) stainless steel spacer, a wave spring, and an anode cap.

TABLE 1
Performance data for traditional cells and cells with active materials on separator.

| Cell number | LM004 | ML005 | LM006 | LM014 | LM015 | LM016 |
|---|---|---|---|---|---|---|
| Cell capacity | 4.73 | 4.73 | 4.37 | 4 | 4 | 4 |
| (mAh) | | | | | | |
| NP ratio | 1.97 | 1.73 | 1.42 | 1.03 | 1.01 | 1 |
| Cell type | graphite on | graphite on | graphite on | graphite on | graphite on | graphite on |
| | Separator, 2 | separator, 2 | separator, 2 | copper, 1 | copper, 1 | copper, 1 |
| | separators | separators | separators | separator | separator | separator |
| Capacity for | 1.1825 | 1.1352 | 1.4663 | 1.28 | 1.32 | 1.84 |
| 3 C charge | | | | | | |
| (mAh) | | | | | | |
| Percentage of | 25% | 24% | 31% | 32% | 33% | 46% |
| total capacity | | | | | | |
| for 3 C | | | | | | |
| Capacity for | 0.6149 | 0.3784 | 0.4257 | 0.32 | 0.44 | 0.96 |
| 5 C charge | | | | | | |
| (mAh) | | | | | | |
| Percentage of | 13% | 8% | 9% | 8% | 11% | 24% |
| total capacity | | | | | | |
| for 5 C | | | | | | |
| Capacity for | 0.2838 | 0.1419 | 0.1419 | 0.12 | 0.12 | 0.2 |
| 7 C charge | | | | | | |
| (mAh) | | | | | | |
| Percentage of | 6% | 3% | 3% | 3% | 3% | 5% |
| total capacity | | | | | | |
| for 7 C charge | | | | | | |

For the traditional cells and cells formed as described herein and shown in Table 1 they were allowed an approximately 5 hour rest, ran 3 formation cycles at C/10, then 6 cycles of 3C charge and C/2 discharge with approximately 20 minutes of voltage hold after each charge and discharge, then 6 cycles of 5C charge and C/2 discharge with approximately 20 minutes of voltage hold after each charge and discharge, then 6 cycles of 7C charge and C/2 discharge with approximately 20 minutes of voltage hold after each charge and discharge. However, cells formed as described herein did not have a C/2 discharge.

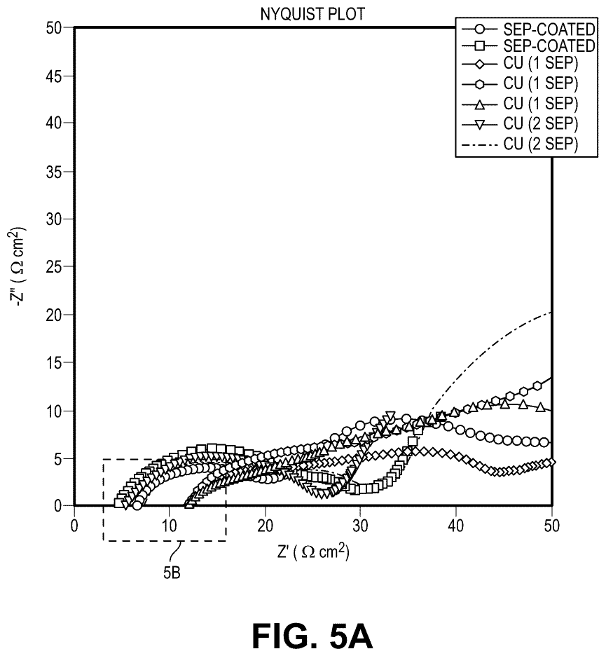

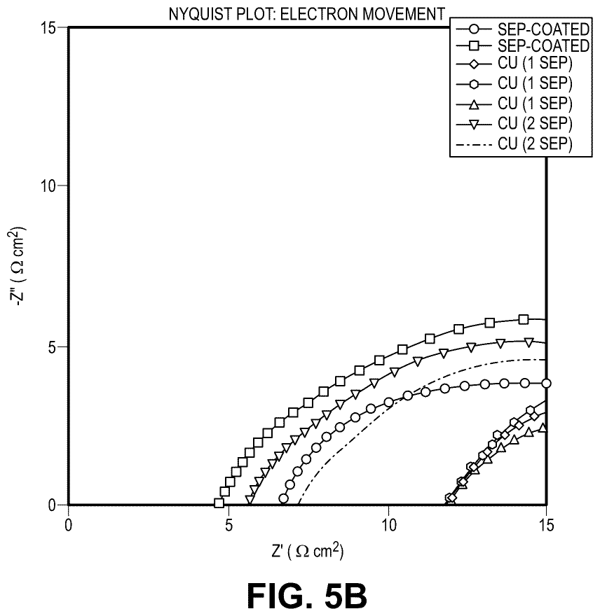

FIGS. 5A and 5B illustrates a Nyquist plot (FIG. 5A) and a Nyquist plot: electron movement (FIG. 5B) for electrodes on a separator of a lithium-ion battery, according to some aspects of the present disclosure. All cells display quite different behavior that is not necessarily dependent on whether the anode is coated on a copper current collector or the separator or whether the cell has two separators. FIGS. 5A and 5B illustrate how the cells formed as described in this present disclosure (i.e., separator-coated cells) perform at least as well as traditional cells (i.e., copper coated cells) in terms of electron movement.

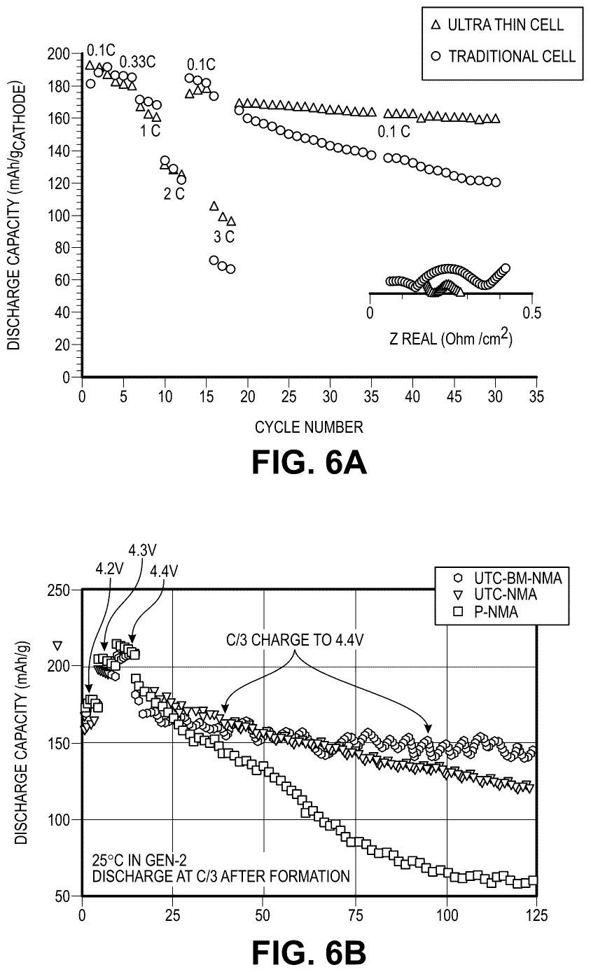

FIGS. 6A and 6B are plots of cycling data comparing the cathode specific capacity of cells manufactured with traditional or ultra-thin current collectors (FIG. 6A). Cycling data from the literature showing the cathode specific capacity for cells with the same architecture of a traditional cell is shown in FIG. 6B, in accordance with the present disclosure. In examples of the present disclosure, cycle life testing was also performed on pouch cells containing a traditional cell architecture and cells containing ultra-thin current collectors. In these tests, traditional Al and Cu foils were replaced with thermally evaporated thin films approximately 94% thinner than standard current collectors, achieving thicknesses of about 0.5 μm. The electrodes contained 90% active material by weight for a nickel-rich NMA cathode and graphite anode. Electrode area for the pouch cells was 12.25 cm² with electrode loadings of 2.5 mAh/cm² (FIG. 6A).

Batteries utilizing these ultrathin current collectors have demonstrated no reduction in storage capacity compared to traditional designs (~195 mAh/g_{cathode} for both cell types). However, cells as described herein have increased capacity retention after 50 cycles (159 mAh/g_{cathode} compared to 120 mAh/g_{cathode}). It is unclear what may be causing the increased capacity retention at this time, but the decline in cycle life in the traditional cells matches that of similar cells found in the literature (“PNMA” in FIG. 6B). With that being said, it is also evident from the data shown in FIGS. 6A and 6B that the presence of ultra-thin current collectors is not detrimental to battery performance.

Without being bound by any particular theory, it is believed that the increased cycle life retention may result from a semi-porous ultra-thin current collector that allows expansion and contraction with the active material and the escape of gases formed during high-voltage cycling. Electrochemical impedance spectroscopy performed on both pouch cells after 50 cycles shows different values of electrical and ionic resistance, but these measurements can be difficult to interpret since the current collector-black mass contact area varies between the two cell architectures.

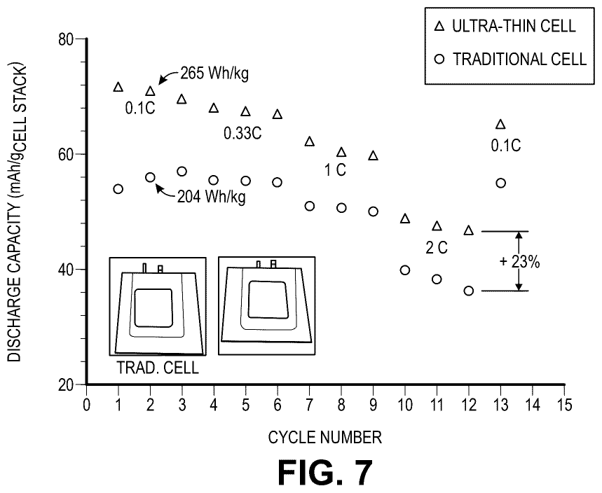

FIG. 7 is a plot exhibiting cycling data comparing the cell stack specific capacity of cells manufactured with traditional or ultra-thin current collectors, in accordance with the present disclosure. In further tests including batteries incorporating the ultra-thin current collectors as described herein, they have shown promising results at the pouch cell level. In these tests, traditional Al and Cu foils were replaced with thermally evaporated thin films approximately 94% thinner than standard current collectors, achieving thicknesses of about 0.5 μm. The electrodes contained 90% active weight of a nickel-rich NMC cathode and graphite anode. Electrode area for the pouch cells was 12.25 cm² with electrode loadings of ~2.5 mAh/cm². Batteries utilizing these ultrathin current collectors have demonstrated no reduction in storage capacity compared to traditional designs (~195 mAh/g_{cathode} for both cell types), but have a substantial increase in cell stack specific energy (71 mAh/g cell stack compared to 56 mAh/gcell stack), a 21% increase at 0.1C or 265 Wh/kg compared with 204 Wh/kg for these non-optimized electrodes. Moreover, initial rate tests indicate that these batteries may even support faster charging times than conventional cells, achieving a 23% increase when charged and discharged at 2C. Modeling suggests that optimized nickel-rich cathode cells could reach >400 Wh/kg with 0.5 μm current collectors. The data shown in FIG. 7 is normalized to the weight of the cell stack, showing clear evidence that the cells including an ultra-thin current collector demonstrate enhanced discharge capacity as compared to traditional cells.

Additional aspects of the present disclosure relate to lithium-ion batteries and methods of manufacture in which a polymeric separator can function as the sole mechanical substrate for the electrochemically active materials, i.e., the anode and cathode, thereby eliminating conventional metal-foil electrode substrates and enabling reduced weight, reduced thickness, and improved energy density.

In examples of the present disclosure, the battery architecture can include a lithium-ion battery that includes a polymeric separator sheet having opposed first and second surfaces. The separator provides primary mechanical support for battery components and exhibits tensile strength comparable to aluminum or copper foil while having lower density. Suitable separator materials include synthetic resins such as polyethylene (PE), polypropylene (PP), aramid-reinforced nonwoven separators, cellulose-based separators, composite solid state-electrolytes, or combinations thereof. A first electrochemically active material layer can be coated directly onto the first surface of the separator to form an anode, and a second electrochemically active material layer is coated directly onto the second surface to form a cathode. The active materials may include lithium-based compounds, for example, lithium oxides, mixtures of multiple lithium compounds, graphite, NMC-type cathode materials, such as NMC811, or other conventional anode and cathode chemistries. In some examples, active material is applied to only one side of the separator.

In examples, the separator serves as the sole mechanical substrate for the electrochemically active material layers, such that neither electrode requires a traditional copper or aluminum foil backing. The batteries or electrochemical subassemblies of the present disclosure can further include an electrolyte disposed between the anode and cathode. In some examples, the electrolyte comprises a synthetic resin-based formulation with enhanced conductivity, chemical stability, and wettability relative to conventional electrolytes. In certain examples, the electrolyte has a specific gravity less than that of water and may include additives to improve compatibility with separator and electrode materials. In still other examples, the electrolyte can be disposed within one or more of a plurality of pores within a porous cathode or porous anode material. In such examples, the electrolyte can also be in direct contact with the second side of the separator layer.

In the present disclosure, current collectors provide an electrical contact with each electrochemically active material layer in the form of stand-alone current collectors that are free of active material. The current collectors may comprise electrically conductive mesh, fabric, felt, or non-woven cloth, and/or thin metal films having a thickness of approximately 0.1 μm to 0.3 μm, or from about 0.1 μm to about 1.0 μm, or from about 0.1 μm to 0.5 μm. Exemplary materials for current collectors of the present disclosure include non-woven copper cloth, copper-nickel (CuNi) coated felt, or other fabric-type conductive structures offering high conductivity, mechanical strength, and chemical stability. The reduced thickness of these current collectors contributes to lower internal resistance and increased volumetric and gravimetric energy density. Other metals known to one skilled in the art can also be utilized as exemplary materials for current collectors, such as copper, aluminum, nickel, carbon-based materials, metallic composites, conductive polymers, or alloys or combinations thereof. In certain examples, current collectors can be deposited or formed by thermal evaporation, sputtering, electrodeposition, or combinations thereof, and may optionally be configured in a tab-less architecture to promote uniform current distribution. A tab-less battery architecture includes a configuration in which the electrode current collectors are electrically coupled to external terminals without the use of localized tab structures, such that current can be drawn from multiple points or substantially the entire edge or surface of the current collector. This results in a distributed current flow rather than current being funneled or limited through one or more discrete tabs.

In the present disclosure, manufacturing methods for forming the lithium-ion battery can include coating active materials directly onto one or both sides of the separator material, thereby forming electrode layers without any additional interceding metal-foil substrates. The coating may be performed using roll-to-roll processing, including the use of tension rolls to maintain uniform thickness and minimize defects. Active materials may be applied in single or multiple layers, and optional calendaring steps may be performed to improve surface smoothness, reduce porosity, and enhance interfacial contact. In some examples, active materials or conductive layers can deposited by electrodeposition.

In exemplary batteries formed according to the materials and methods described in the present disclosure, batteries formed may exhibit specific energy densities exceeding about 100 Wh/kg, volumetric capacities of at least about 500 Wh/L, reduced internal resistance, and increased energy storage per unit volume due to elimination of thick metal-foil current collectors. In examples, the volumetric capacities can be up to about 440 Wh/kg, or up to about 990 Wh/L. The batteries as disclosed may be configured as coin cells, pouch cells, cylindrical cells, prismatic cells, or in other lithium-ion battery formats.

The foregoing discussion and examples have been presented for purposes of illustration and description. The foregoing is not intended to limit the aspects, embodiments, or configurations to the form or forms disclosed herein. In the foregoing Detailed Description for example, various features of the aspects, embodiments, or configurations are grouped together in one or more embodiments, configurations, or aspects for the purpose of streamlining the disclosure. The features of the aspects, embodiments, or configurations may be combined in alternate aspects, embodiments, or configurations other than those discussed above. This method of disclosure is not to be interpreted as reflecting an intention that the aspects, embodiments, or configurations require more features than are expressly recited in each claim. Rather, as the following claims reflect, inventive aspects lie in less than all features of a single foregoing disclosed embodiment, configuration, or aspect. While certain aspects of conventional technology have been discussed to facilitate disclosure of some embodiments of the present invention, the Applicants in no way disclaim these technical aspects, and it is contemplated that the claimed invention may encompass one or more of the conventional technical aspects discussed herein. Thus, the following claims are hereby incorporated into this Detailed Description, with each claim standing on its own as a separate aspect, embodiment, or configuration.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A lithium-ion battery, comprising:
a first separator material comprising a polymer, the first separator material having a first side and a second side opposite to the first side;
a first active material disposed directly on the first side of the separator material;
a second separator material, comprising a polymer having a first side and a second side; and
a second active material disposed directly onto the second side of the separator material.
an electrolyte in contact with the second active material; and
a current collector in contact with the first active material or the second active material and comprising a fabric, a film, a metal, or a combination thereof.

2. The lithium-ion battery of claim 1, wherein the separator material comprises a synthetic resin comprising polyethylene (PE), polypropylene (PP), or a combination thereof.

3. The lithium-ion battery of claim 1, wherein the first active material comprises an anode.

4. The lithium-ion battery of claim 1, wherein the current collector comprises copper nickel (CuNi) coated felt, non-woven copper cloth, or a combination thereof.

5. The lithium-ion battery of claim 1, wherein the current collector has a thickness of from about 0.1 μm to about 0.3 μm.

6. The lithium-ion battery of claim 1, comprising a capacity to store at least 500 Wh/L per unit volume.

7. The lithium-ion battery of claim 1, wherein the second active material comprises a porous material;
the electrolyte is disposed within one or more of a plurality of pores in the second active material; and
the electrolyte is in contact with the second side of the separator.

8. The lithium-ion battery of claim 1, wherein:
the separator comprises a porous material; and
the electrolyte is disposed within one or more of a plurality of pores in the separator.

9. The lithium-ion battery of claim 1, wherein the second active material comprises a cathode.

10. The lithium-ion battery of claim 1, wherein the battery is configured as a coin cell or a pouch cell.

11. The lithium-ion battery of claim 1, wherein the battery comprises a specific energy density greater than 100 Wh/kg.

12. The lithium-ion battery of claim 3, wherein the anode comprises graphite, lithium, or a combination thereof.

13. A method of manufacturing a lithium-ion battery, the method comprising:
providing a continuous polymeric separator web having first and second opposed surfaces;
roll-to-roll coating a slurry containing an electrochemically active material directly onto at least one of the first and second surfaces to form an active material layer to form a separator-supported electrode;
drying the coated continuous polymeric separator web;
connecting a conductive current-collector layer to the active material layer, the current-collector layer having a thickness of less than 1.0 μm and being free of active material; and
assembling the separator-supported electrode into a lithium-ion cell together with a counter-electrode, an electrolyte, and a housing.

14. The method of claim 13, wherein depositing a conductive current-collector layer comprises laminating onto the active material layer a CuNi-coated felt or non-woven copper cloth having a thickness from about 0.1 μm to about 0.3 μm.

15. The method of claim 13, wherein connecting a conductive current-collector layer comprises depositing by a process comprising thermal evaporation, sputtering, electrodeposition, or a combination thereof.

16. The method of claim 13, wherein:
the electrochemically active material is coated onto both the first and second opposed surfaces; and
drying the coated continuous polymeric separator web and depositing a conductive current-collector layer onto the active material layer are performed on each of the first and second opposed surfaces to provide opposing anode and cathode electrodes on the separator web before assembling.

17. A lithium-ion battery sub assembly, comprising:
a polymeric separator sheet having a first surface and a second surface, the second surface on an opposite side of the first surface;
a first electrochemically active material layer directly disposed on the first surface of the separator sheet;
a second electrochemically active material layer directly disposed on the second surface of the separator sheet; and
a current collector in electrical contact with the first or second electrochemically active material layer, the current collector being free of either the first or second electrochemically active material.

18. The lithium-ion battery sub assembly of claim 17, wherein the first electrochemically active material layer comprises an anode.

19. The lithium-ion battery sub assembly of claim 17, wherein the current collector comprises an electrically conductive mesh, fabric, film, non-woven cloth, or a combination thereof;
the current collector comprises metal; and
the current collector has a thickness of from about 0.1 μm to about 0.3 μm.

20. The lithium-ion battery sub assembly of claim 17, further comprising:
an interfacial layer disposed between the first electrochemically active material layer and the current collector; and
wherein the interfacial layer is non-carbonaceous and comprises a conformal, electronically conductive adhesion layer selected from a conductive polymer network, a metal oxide, a metal nitride, or a combination thereof, the interfacial layer having a thickness from about 50 nm to about 800 nm.
